(19) United States
(12) Patent Application Publication
(10) Pub. No.: US 2006/0088401 A1
(43) Pub. Date: Apr. 27, 2006

(54) Tamper-proof sealing mechanism for various adjustment means

(75) Inventors: Ramanuja Rajagopal Radhavan, Mumbai (IN); Pravesh Gope Hiranandani, Mumbai (IN)

Correspondence Address: Colin P. Abrahams;Suite 400, 5850 Canoga Avenue, Woodland Hills, CA, 91367, US

(73) Assignee: Mahindra & Mahindra Ltd

(21) Appl. No.: 10/987,582

(22) Filed: Nov. 12, 2004

(30) Foreign Application Priority Data
Oct. 26, 2004 (IN) 1142/MUM/2004

(51) Int. Cl. F16B 37/14

(52) U.S. Cl. 411/372.5

(57) ABSTRACT

A tamper-proof sealing mechanism for protecting various adjustment/setting means comprises a sleeve (5) having cylindrical bores on either side of its middle wall (14) for covering the adjustment means (1, 2 & 3) from one side and sleeve locking nut (6) or alike from another side. A spring washer (13) or the like is provided on both the side of the middle wall (14) of the sleeve (5) for proper nut tightening. A sleeve locking nut (6) is provided next to the spring washer (13) i.e. from opposite side of the adjustment means. A plug (7) is positioned on one side of said sleeve (5) i.e. at counter bore (10) or the like to form permanent sealing in between plug (7) & sleeve (5).

### FIELD OF INVENTION

The present invention relates to provision of tamper-proof sealing mechanism for protecting various adjustment means such as adjustment screws/nuts/bolts of fuel injection pump (FIP) or alike, to eliminate or avoid the possibility of resetting by disturbing original setting of these adjustment means other than recommended source. This will discourage or restrict users from fiddling with such adjustment means of FIP or alike, which further affects vehicle performance, inadequate warranty claims & various emission norms.

### BACKGROUND OF INVENTION

The Fuel Injection Pump (FIP) is heart of diesel engine, which supplies the required quantity of fuel as per speed and load conditions. Different fueling adjustments are carried out to achieve better vehicle performance and various emission norms through an external access, which are described as low Idle, high Idle and full load adjustment means such as screws/nuts/bolts. These adjustments are determined by the manufacturer as suitable for the vehicle and the user of the vehicle or any unauthorized person should not disturb these settings as it may have an adverse effect on performance. After necessary fueling adjustment at the manufacturer's end by using a standard FIP test bench, these adjustment means are sealed before handing over the FIP to customer. At the same time there should be some means which gives the indication of any changes in fuel setting carried out at the user's end, to avoid warranty claims on fueling adjustments at user end.

In current practices the locking (sealing) mechanism provided by certain manufactures is not able to completely fulfill the desired requirements. The regular practice of providing tag wire and metal seal have not sufficiently discouraged operator(s) from adjusting these adjustment means to their particular desires.

There have been periodic attempts to overcome the shortfall in the tag wire and metal system. For example, in U.S. Pat. No. 4,470,789 an attempt has been made to create a tamper-resistant seal for discouraging unauthorized access to an adjusting screw located in a fuel injection pump. According to this invention a separate cover and bracket are provided to cover the adjustment screw by using combination of studs, one-way fasteners, push-on fasteners and the like. Although the invention could discourage users and unauthorized personnel from tampering with the adjustment screws, in actuality the invention is of a mechanism which is too complicated and has a number of components which unnecessarily increases the seal size, packaging constraints, operating costs and time.

Another attempt has been made by U.S. Pat. No. 4,308,220 to provide for the enclosure of the adjustment screw or the like within a closed chamber provided by a tubular surrounding wall and sealing plug. The mechanism under this invention can be opened by means of a special tool which in today's scenario can be obtained with ease giving rise to disputes as the seal would not be damaged.

In U.S. Pat. No. 4,273,730 a tamper resistant device has been created for a carburetor idle adjustment screw. In this invention a cavity has to be created on the carburetor body above the adjustment screw and a blocking pin is placed between the adjustment screw and a plug, blocking the access to the adjustment screw from the outer end of the carburetor. The mechanism does not suit any other device other than a carburetor and does not prevent manipulation of various FIP adjustment screws at the user end. Additionally in case of any damages during authorised/unauthorized use, to the area where the locking members are provided will cause complete replacement of whole carburetor body.

All of the above Patents have limitations in their applications.

Therefore, it is necessary for a manufacturer to provide simpler, compact in design, cost effective Tamper-proof locking (sealing) mechanism for various adjustment means of FIP or alike either commonly or separately, which will ensure fuel or alike setting to be done by authorized source on standard FIP test bench only. The adjustment of fuel setting is carried out at the outset to achieve better vehicle performance & various emission norms forever and identification of any disturbance in fuel adjustment at user can be easily identified to negative wrongful warranty claims.

### SUMMARY OF THE INVENTION

Therefore it is an aspect of this invention to provide a simpler, compact, cost effective tamper-proof locking (sealing) mechanism for various adjustment means such as adjustment screws/nuts/bolts of fuel injection pump (FIP) or alike, which will ensure fuel or alike setting only on standard FIP test bench as per specification.

Another aspect of the present invention is to discourage/restrict users from fiddling with FIP fuel setting without referring to authorized source, thereby maintaining standard & better vehicle performance with various emission norms forever.

Another aspect of the present invention to avoid inadequate/faulty warranty claims created because of disturbing original FIP fuel settings by unauthorized source.

Other aspects and features of the present invention will be apparent to those skilled in the art, based on the following description taken in combination with the accompanying drawings & can be used in other sealing areas depending up on the requirements & benefits.

### BRIEF DESCRIPTION OF THE DRAWING

FIG. 1 shows the fuel injection pump (without engine) along with various fuel adjustment screws; and

FIG. 2 shows at least one type of tamper-proof sealing mechanism developed for sealing the FIP or alike adjustment screws.

### DETAILED DESCRIPTION OF THE PREFERRED EMBODIMENTS

To eliminate problems created by tampering of these adjustment means pertaining to fueling adjustments of the FIP, it is desired to have a tamper-proof seal mechanism which will avoid easy access to these adjustment means, thereby avoiding fiddling with these adjustment means at customer end without referring authorized the FIP setting source.

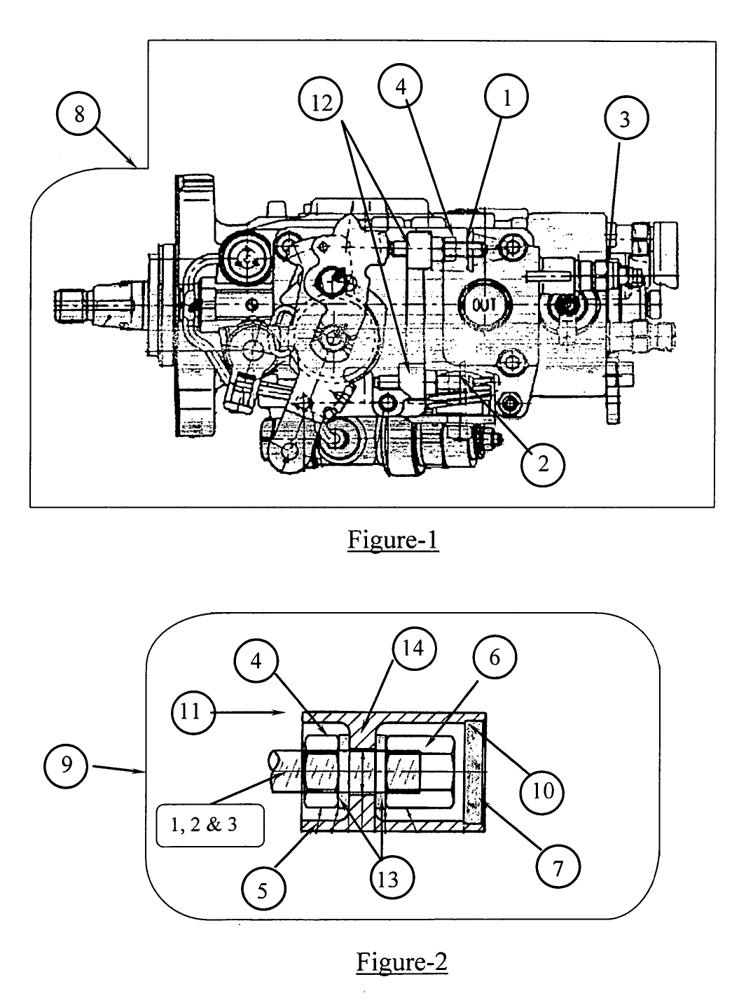

The invention is explained in accordance with the drawings shown in FIGS. 1 and 2, in which adjustment means (hereafter referred as screws) Low Idle (1), High Idle (2) and Full Load (3) are at there their respective locations on FIP (8). Each of these screws (1, 2 and 3), are adjusted as per the specification for better vehicle performance and various emission norms requirement, at the manufacturer's end and locked at their final position. Depending upon the adjustment screws locking arrangement screw locking nut (4) may be provided on each adjustment screw (1, 2 & 3).

In order to adjust these screws (1, 2 & 3), screw locking nut (4) has to be loosened. Therefore, by covering this locking nut (4) by tamper-proof sealing mechanism (9), access can be denied from unauthorized users.

According to the requirement for a tamper-proof seal, at least one type of seal mechanism is shown in FIG. 2, in which sleeve (5) having cylindrical bores on either side of its middle wall (14) is mounted in such a way to cover fuel adjustment screws (1, 2 & 3) with or without screw locking nut (4). Sleeve (5) is locked against the FIP body (12) with sleeve locking nut (6) entered from opposite side cylinder bore of fuel adjustment screws. Thereby sleeve (5) is locked against pump body surface/plan (12) covering adjustment screws and/or screw locking nut. Spring washers (13) are provided on either side of the middle wall (14) of the sleeve (5), for proper nut tightening. Part of the FIP body (12) covers one side of the sleeve (5) and the other side of the sleeve (5) is to be closed by using plug (7) having permanent sealing with sleeve (5). Counter bore (10) or alike thing is provided on sleeve (5) to ensure permanent sealing of the plug (7).

To adjust adjustment screws (1, 2 & 3) of the FIP access to the screw locking nut (4) is required. As a general practice, user may try to open this tamper-proof sealing mechanism (9) by hammering the sleeve (5) in the direction (11) as shown in FIG. 2. Since the sleeve (5) is fixed with sleeve lock nut (6), it will not allow removal of sleeve (5).

The only way to get access to the screw locking nut (4) is by removing sleeve (5). This is possible when plug (7) is tempered by means of drilling or alike operations and subsequently unlocking sleeve lock nut (6). In this process, plug (7) will gets permanently damaged and user can not replace with similar type of plug (7) and the tamper-proof sealing mechanism (9) can be seen to be tampered.

Hence tamper-proof sealing mechanism (9), which is simpler, compact in design, effective in cost and serviceability helps in avoiding users from fiddling with the various adjustment means such as screws/nuts/bolts of the FIP or alike without referring to an authorized source. Thereby maintaining vehicle performance and emission norms by setting the fueling or alike as per specifications by authorized source only. Also this will reduce the faulty claims pertaining to disturbing original FIP settings at the user end.

As various changes could be made in the above construction without departing from the scope of the invention, it is intended that all matter contained in the above description & shown in the accompanying drawings shall be interpreted as illustrative and not in a limiting sense.

1. A tamper-proof sealing mechanism (9) for protecting various adjustment/setting means comprising:
a sleeve (5) having cylindrical bores on either side of its middle wall (14) for covering said adjustment means (1, 2 & 3) from one side and sleeve locking nut (6) or alike from another side,
a spring washer (13) or alike means provided on both the side of said middle wall (14) of said sleeve (5) for proper nut tightening,
a sleeve locking nut (6) provided next to said spring washer (13) i.e. from opposite side of said adjustment means,
a plug (7) is positioned on one side of said sleeve (5) i.e. at counter bore (10) or alike to form permanent sealing in between plug (7) & sleeve (5).

2. A temper-proof sealing mechanism as set forth in claim 1, in which easy access to said sleeve locking nut restricted or hindered by providing permanent sealing of said plug at said counter bore and access to said adjustment means is denied by locking the said sleeve with said sleeve locking nut against the surface/plan (12) on which said adjustment/setting means is provided.

3. A tamper-proof sealing mechanism as set forth in claim 1 could be used either commonly or separately for protecting various adjustment means such as setting screws/nuts/bolts of fuel injection pump (8) or alike mechanisms requires authorised/recommended source for readjustment/resetting.

4. A tamper proof sealing mechanism (9) for protecting various means for adjustment, said sealing mechanism comprising:
a sleeve (5) having two cylindrical bores on opposing sides of an inner middle wall (14), said cylindrical bores comprising a first cylindrical bore for covering said means for adjustment (1, 2, 3) at a first side of said inner middle wall (14), and a second cylindrical bore for covering a sleeve locking nut (6) or the like at a second side of said inner middle wall (14);
a spring washer (13) or the like provided on both sides of said middle wall (14) of said sleeve (5) for properly securing said sleeve (5);
a sealing plug (7);
wherein said sleeve locking nut (6) is located adjacent to one of said spring washers (13) or the like in said second cylindrical bore;
wherein said second cylindrical bore is provided with a counter bore (10), which receives said sealing plug (7) and forms a permanent seal between said sleeve (5) and sealing plug (7).

5. The tamper-proof sealing mechanism (9) of claim 1, wherein easy access to said sleeve locking nut (6) is prevented by providing permanent sealing of said sealing plug (7) within said counter bore (10) of said second cylindrical bore of said sleeve (5), and wherein any access to said means for adjustment (1, 2, 3) is denied by locking said sleeve (5) against a surface (12) to which said means for adjustment (1,2,3) is provided, using said sleeve locking nut (6).

6. The tamper-proof sealing mechanism (9) of claim 1, wherein said mechanism (9) can be used for protecting various means for adjustment (1, 2, 3), including any one of screws, nuts, and bolts of a fuel injection pump (8) or the like, which might require authorized readjustment or resetting.
